(19) United States
(12) Patent Application Publication
(10) Pub. No.: US 2013/0209202 A1
(43) Pub. Date: Aug. 15, 2013

(54) LOAD BEARING DEVICE FOR A RACK RETRIEVAL SYSTEM, RACK RETRIEVAL SYSTEM, AND STORAGE SYSTEM

(71) Applicant: SSI Schafer Noell GMBH Lager-und Systemtechnik, (US)

(72) Inventors: Rob A. Schmit, Lake Wylie, SC (US); Rainer Steinbach, Himmelstadt (DE)

(73) Assignee: SSI SCHAFER NOELL GMBH LAGER-UND SYSTEMTECHNIK, Giebelstadt (DE)

(21) Appl. No.: 13/731,399

(22) Filed: Dec. 31, 2012

Related U.S. Application Data
(63) Continuation of application No. 13/591,522, filed on Aug. 22, 2012.

(30) Foreign Application Priority Data
Feb. 23, 2010 (DE) 10 2010 009 873.6
Feb. 16, 2011 (EP) PCT/EP2011/052308

(51) Int. Cl. B65G 1/06

(52) U.S. Cl. CPC B65G 1/06
USPC 414/279; 414/807

(57) ABSTRACT

A load handling device of a storage and retrieval device, which can travel in a longitudinal direction along a storage and retrieval side of a storage rack and can be positioned in front of the storage and retrieval side so that storage goods can be stored and retrieved in a transverse direction, including a loading platform; at least one tine comb comprising a plurality of tines which are substantially oriented along the transverse direction and are distanced to each other so that each of the tines can engage a space between neighbouring cantilever arms of the storage rack for delivering or lifting one or more of the storage goods on the cantilever arms or from the cantilever arms.

### CROSS REFERENCES TO RELATED APPLICATIONS

This application is a continuation of the international patent application PCT/EP2011/052308 (WO 2011/104157 A1), filed on Feb. 16, 2011, designating the U.S., said international application has been published in the German language and claims priority from the German patent application 10 2010 009 873.6 filed on Feb. 23, 2010. The entire contents of these priority applications are incorporated herein by reference.

### BACKGROUND OF THE INVENTION

The present invention relates to a load handling device of a storage and retrieval device which can travel in a longitudinal direction along a storage and retrieval side of a storage rack and which can be positioned in front of the storage and retrieval side so that storage goods can be stored and retrieved in a transverse direction. Further, the present invention relates to a storage and retrieval device having a corresponding load handling device. Additionally, the present invention relates to a warehouse system having a corresponding storage and retrieval device. Finally, the invention also relates to a method for storing and retrieving storage goods in and from a storage rack by means of a corresponding storage and retrieval device.

### RELATED PRIOR ART

Conventional storage and retrieval devices are often used in rack aisles of a rack warehouse for storing and retrieving storage goods in and from rack storage locations. In high bay warehouses the storage and retrieval devices (hereinafter also briefly designated as “SRD”) are often used for handling pallets, in particular Europool pallets. The pallets are typically received in a goods receipt and then stored in the high bay warehouse by means of the SRD. The pallets can also be retrieved again by means of the SRD for the purpose of removing one or more packing goods which are delivered on the pallets. The storage and retrieval is conducted by means of a load handling device such as a (telescopic) fork. Typical telescopic forks comprise one or two tines which can be moved, for example, beneath one of the pallets and the distance of which is selected so that the tines can move into spaces at the bottom side of the pallets. The SRD is provided with a hoist unit which is not only used for positioning a lifting platform, on which the load handling device is arranged, at a height of a desired storage location but also for delivering or lifting one of the pallets which is to be retrieved or stored as soon as the fork is located in a suitable position.

The documents U.S. Pat. No. 3,633,769 and US 493,542 disclose storage and retrieval devices which interact in a meshing manner with correspondingly formed racks. A lift, which is required for storage or retrieval, is effected by a hoist unit of the storage and retrieval device.

The document DE 20 2009 009 774 U1 describes a rack warehouse which is supplied with articles by means of an SRD for the purpose of storage and retrieval. But the articles (e.g. packed into cartons) are not provided as usual on additional load supports (e.g. trays) but are to be stored in the rack warehouse without the load supports. For this purpose the articles are handed over to a load handling device of an SRD without load supports. The load handling device is equipped with horizontally movable fork-shaped tines, which correspond to a profiled shelf. The article is positioned by means of the load handling device of the SRD in front of a selected empty compartment for delivering the article to the compartment, and moved by means of the extracted tines of the load handling device over the shelf so that the tines engage into corresponding recesses of the shelf after a defined downward movement due to the hoist unit of the SRD, thereby delivering the article on the surface of the shelf. Then, the extracted tines are horizontally retracted from the recesses of the shelf to the lifting platform. The load handling device conducts, during retrieval from the rack, a vertical lifting movement (relative lift) by the hoist unit of the SRD for lifting the article from the shelf.

If the hoist unit of the SRD needs to be operated for lifting or retrieving one of the storage goods, as a rule, a storage-good transfer at both sides is not possible. With the storage-good transfer at both sides an exchange of one of the storage goods happens with both a rack on the left-hand side and right-hand side of the rack aisle.

Additionally, a needless amount of mass (hoist unit and entire load handling device) needs to be moved, resulting in increased energy consumption and a higher inertia (lower velocity).

Since the lifting and lowering of the load handling device happens by means of the hoist unit of the SRD, high control effort (obeyance of security regulations, monitoring, etc.) is required, which needs to be handled typically by the control device of the SRD.

The document DE 200 11 495 U1 discloses a tower-like rack for storing vehicles. The vehicles are stored and retrieved by means of a stationary elevator. A load handling device of the elevator comprises two transfer arms pivotally supported, which are pivoted by means of a horizontally movable wedge device.

The document U.S. Pat. No. 3,232,465 A discloses two-way fork structure for a side shifting load carrier. The side shifting load carrier is designed for use upon loadsupporting vehicles, such as fork lift trucks. The fork structure comprises two forks which are connected to each other in an L-shape. FIG. 2 shows the fork structure in a first orientation for serving a left-hand side of a rack aisle. FIG. 3 shows the fork structure in a second orientation for serving a right-hand side of the rack aisle, wherein the rack aisle is defined between two spaced apart neighbouring racks extending along a longitudinal direction of the aisle. The second orientation is achieved by clockwise rotating the L-shaped double fork around 90 degree. The double fork is linearly displaceable in a horizontal direction for entering and exiting rack compartments. The double fork is linearly movable in a vertical direction for lifting and lowering storage goods from and on the rack compartments.

### SUMMARY OF THE INVENTION

Therefore, it is an object of the present invention to provide an enhanced load handling device, an enhanced storage and retrieval device, an enhanced warehouse system as well as an enhanced method for storing and retrieving storage goods.

According to a first aspect of the invention a load handling device is disclosed, wherein the load handling device comprises: a loading platform; at least one tine comb having a plurality of tines being substantially oriented along the transverse direction and being distanced to each other so that each of the tines can engage a space between neighbouring cantilever arms of the storage rack, in order to deliver one or more storage goods on the cantilever arms or to lift same from the cantilever arms, wherein the tines are connected to each other in the longitudinal direction by means of a tine support; a driving device for retracting and extracting each of the tine combs in and from the spaces in the transverse direction; and a rotation device for rotating the at least one tine comb, if the tines thereof are located in the spaces between the neighbouring cantilever arms of the storage rack, about a rotation axis being oriented parallel to the longitudinal direction, thereby allowing an end of the at least one tine comb, which faces the storage rack, to be lifted or lowered in a height direction.

According to a second aspect of the invention a load handling device of a storage and retrieval device is described, which travels in a longitudinal direction of a rack aisle along a storage and retrieval side of a cantilever-arm storage rack, and which can be positioned in front of the storage and retrieval side such that storage goods can be stored and retrieved in a transverse direction, wherein the storage rack comprises a plurality of cantilever arms on which the storage goods are put for storage, wherein the cantilever arms are distanced to each other in the longitudinal direction and substantially extend in the transverse direction, comprising: a loading platform; at least one tine comb respectively comprising a tine support and a plurality of tines which are substantially oriented in the transverse direction and are distanced to each other in the longitudinal direction so that each of the tines can reach into a space between neighbouring cantilever arms of the storage rack for delivering or lifting one or more of the cantilever-arm storage goods on or from the neighbouring cantilever arms, wherein the plurality of tines are connected to each other in the longitudinal direction by means of the tine support; a drive device for retracting and extracting the at least one tine comb in the transverse direction into and from the spaces; and a rotation device for rotating the at least one tine comb for the delivering and lifting the one or more of the storage goods on and from the cantilever arms, when the tines are in the spaces between the neighbouring cantilever arms of the cantilever-arm storage rack, around a rotation axis, which is oriented parallel to the longitudinal direction, thereby allowing one end of the at least one tine comb, which is facing the cantilever-arm storage rack, to be lifted or lowered rotationally in a height direction.

The tine comb allows handling of the load goods without load supports.

Lifting the storage goods by means of the hoist unit of the SRD can be given up completely since the tine comb is supported rotatably. If one of the storage goods is located on the tine comb for being stored, then the tine comb only needs to be lowered by means of a rotation as soon as the tine comb meshes with the correspondingly formed cantilever arms of the storage rack. The tines are located beneath the cantilever arms of the storage rack after the tine comb is lowered. Then, the SRD can already travel again along the longitudinal direction for moving to a new storage-good transfer position. During the travel the load handling device can be tilted back into a horizontal orientation and retracted on the loading platform in the horizontal direction to the starting position thereof. In this manner time can be saved since the SRD can be moved earlier in the direction X. Waiting before the actual travel of the SRD starts, is no longer required for the load handling device of the SRD being located in the starting position thereof.

The control is facilitated considerably. The lowering of the tine comb, and respectively the end thereof facing the rack and arranged at the outside, can be achieved alone by horizontally extracting the tine comb in combination with a mechanical guidance link for initiating the rotation process. A sensor inquiries whether the SRD or the hoist unit thereof are located at the right position are unnecessary, but without less safety.

If the load handling device is provided with two oppositely movable tine combs two rack locations being arranged oppositely relative to the rack aisle can perform a transfer of storage goods simultaneously. Synchronization of the load handling devices as required in accordance with the prior art is not required since each of the tine combs can be rotated individually, and thus can be lifted and lower individually. If the lift occurs by means of the hoist unit the SRD has to wait until all of the load handling devices are ready to cause performance of the desired lifting movement by means of the hoist unit of the SRD.

In this connection, it is also to be considered that conventional load handling devices, which have allowed simultaneous storage good handling at both sides of one rack aisle, have always allowed only one and the same process. Either storage or retrieval was done. The load handling device in accordance with the present invention allows storage of one storage good at one of the sides of the rack aisle, while another storage good is retrieved at the opposite side. This effect is enhanced the more load handling devices are arranged sequentially in the longitudinal direction on a loading platform of one SRD.

In accordance with a preferred embodiment the drive device comprises a drive member, in particular an electric motor, and a transmission member, in particular a gear rack, connected to the tine comb.

The drive device allows the tine comb to be moved in the horizontal direction. The tine comb can be moved between the cantilever arms of the storage rack and can be moved therefrom. Gear racks ensure a good transmission of force.

Additionally, it is preferred to arrange the rotation axis in an area of the tine support.

Typically, the tine support is arranged at the inside relative to the storage and retrieval sides of the storage rack. The further the rotation axis is disposed at the inside relative to the tine comb, the greater the lift is, which can be performed by an end of the tine comb facing the storage rack by means of a rotational movement.

With another embodiment the rotation device additionally comprises a shaft to which a plurality of cams can be attached and which is arranged at an edge of the loading platform facing the storage rack so that the first end of the at least one tine comb is lifted and lowered by means of rotating the shaft relative to the cantilever arms, if the tine comb is in an extracted position.

Hence, the shaft is arranged eccentrically relative to the rotation axis and causes the rotational movement of the tine comb. The tines of the tine comb lie on the cams. If the cams are in an upright position the tines of the tine comb can be moved in a horizontal direction while the horizontal orientation thereof is maintained. In this manner it is possible, for example, that the SRD moves storage goods, which are to be stored, into the rack. If the tine comb is then in its extracted position, the cams can be rotated from their upright position by means of a rotation of the additional shaft. Since the rotation axis of the tine comb stays at the identical height during this action merely the end of the tine comb is lowered which is facing the storage rack. The storage good located on the tines of the tine comb is lowered onto the cantilever arms by means of the lowering movement, the cantilever arms meshing with the tines of the tine comb. Then, the tine comb can return in the horizontal direction while it is in the lowered position. As soon as the tine comb is outside of the area of the cantilever arms, the shaft can be rotated back so that the cams are moved again into their upright position, thereby bringing back again the end of the tine comb into the original horizontal position, the end facing the storage rack.

Further it is preferred to provide, in the transverse direction, only one single tine comb which is preferably rotatable additionally about 180° for allowing serving both sides of one rack aisle.

This embodiment is suited particularly for warehouse systems having little space. If the load handling device comprises only one single tine comb in the transverse direction, wherein it is absolutely possible to arrange a number of individual tine combs subsequently in the longitudinal direction on the loading platform, the load handling device is very short in the transverse direction. This allows utilization of the load handling devices with SRD which are used in very small rack aisles.

In order to allow service at both sides of one rack aisle the tine comb is rotatable about 180° in addition to its rotatability for ensuring the lift. By means of a rotation about 180° the left orientation of the tine comb can be changed into a right orientation (or vice versa), wherein the tine comb is still movable along a horizontal line (transverse direction).

With another embodiment of the invention respectively two tine combs are arranged side by side in the transverse direction.

With this embodiment turning of the tine comb is not required for serving both sides of one rack aisle. An individual tine comb is provided for each side of the rack aisle. Of course, it is also possible to arrange several pairs of tine combs, one after the other in the longitudinal direction on the loading platform.

Besides this, it is clear that a length of the tines of each of the tine combs can be selected freely so that single deep and/or multiple deep storage of storage goods is possible. With a multiple deep storage a number of storage goods are stored one after the other in the storage rack along the transverse direction. In this case the cantilever arms are sized correspondingly. Further, it is clear that the tines can also be formed in a telescopic manner.

With another advantageous embodiment an additional transfer conveyor is provided, which is arranged and formed such that one storage good can be transferred from one of the tine combs to another tine comb provided in a neighbouring manner in the transverse direction.

In this manner it is possible that one storage good can be retrieved, for example, from the left side of the rack by means of the left tine comb and is transferred later by means of the transfer conveyor from the left tine comb to the right tine comb and from there to the right side of the rack. This allows transfer of storage goods from one side of the rack aisle to the other side of the rack aisle. Finally, the SRD preferably delivers the storage goods at a front side of the rack aisle to a conveyor, which is adjacent to the racks, or similar (work stations, order-picking stations, etc.). Of course, the SRD can also deliver a retrieved storage good to a work station within one of the adjacent racks. Such a work station can be realized, for example, by means of an order-picking station or a consolidation station where different storage goods are collected, preferably, on an orderload support (e.g. Europool pallet), in order to process a picking order.

According to a third aspect of the invention it is disclosed a storage and retrieval device having a carriage, a hoist unit, at least one mast and at least one load handling device of the above-described type.

According to a fourth aspect of the invention it is disclosed storage and retrieval device being adapted to travel in a longitudinal direction of a rack aisle along a storage and retrieval side of a cantilever-arm storage rack, and to be positioned in front of the storage and retrieval side such that storage goods can be stored and retrieved in a transverse direction, wherein the cantilever-arm storage rack comprises a plurality of cantilever arms on which the storage goods are put for storage, the cantilever arms being distanced to each other in the longitudinal direction and substantially extend in the trans-verse direction, the storage and retrieval device having a carriage, a hoist unit, at least one mast, and at least one load handling device, each of the at least one load handling devices comprises: a loading platform; at least one tine comb respectively comprising a tine support and a plurality of tines which are substantially oriented in the transverse direction and are distanced to each other in the longitudinal direction so that each of the tines can reach into a space between neighbouring cantilever arms of the cantilever-arm storage rack for delivering or lifting one or more of the storage goods on or from the neighbouring cantilever arms, wherein the tines are connected to each other in the longitudinal direction by means of the tine support; a drive device for retracting and extracting the at least one tine comb in the transverse direction into and from the spaces; and a rotation device for rotating the at least one tine comb for the delivering and lifting of the one or more of the storage goods on and from the cantilever arms, when the tines are in the spaces between the neighbouring cantilever arms of the cantilever-arm storage rack, around a rotation axis, which is oriented parallel to the longitudinal direction, thereby allowing an end of the at least one tine comb, which is facing the cantilever-arm storage rack, to be lifted or lowered rotationally in a height direction.

It is clear that the hoist unit and the at least one mast are only provided if the racks which are served by the SRD are formed correspondingly high. If the SRD is only required for serving one single rack plane the hoist unit and the mast can be omitted. In this case one speaks of a one-plane SRD or a shifting car.

According to a fifth aspect of the invention it is disclosed a warehouse system having at least one storage rack and one SRD of the above-described type, wherein the storage rack comprises rack stands and cantilever arms which can be attached to the rack stands, wherein the cantilever arms are distanced to each other so that the tines of the at least one tine comb can travel along the transverse direction into the spaces between neighbouring cantilever arms.

According to a sixth aspect of the invention it is disclosed warehouse system comprising at least one cantilever-arm storage rack having a storage and retrieval side, wherein the cantilever-arm storage rack comprises: a plurality of rack stands and cantilever arms, which are attached to the rack stands, wherein the cantilever arms are distanced to each other in a longitudinal direction and substantially extend in a transverse direction; and a storage and retrieval device, the storage and retrieval device being adapted to travel in the longitudinal direction along the storage and retrieval side of the cantilever-arm storage rack, and being adapted to be positioned in front of the storage and retrieval side such that storage goods can be stored and retrieved in the transverse direction, wherein the storage goods are put on the cantilever arms for storage, the storage and retrieval device having a carriage, a hoist unit, at least one mast, and at least one load handling device, each of the at least one load handling devices comprising: a loading platform; at least one tine comb respectively comprising a tine support and a plurality of tines which are substantially oriented in the transverse direction and are distanced to each other in the longitudinal direction so that each of the tines can reach into a space between neighbouring cantilever arms of the cantilever-arm storage rack for delivering or lifting one or more of the storage goods on or from the neighbouring cantilever arms, wherein the plurality of tines are connected to each other in the longitudinal direction by means of the tine support; a drive device for retracting and extracting the at least one tine comb in the transverse direction into and from the spaces; and a rotation device for rotating the at least one tine comb for the delivering and lifting the one or more of the storage goods on and from the cantilever arms, when the tines are in the spaces between the neighbouring cantilever arms of the cantilever-arm storage rack, around a rotation axis which is oriented parallel to the longitudinal direction, thereby allowing an end of the at least one tine comb, which is facing the cantilever-arm storage rack, to be lifted or lowered rotationally in a height direction.

Preferably, several cantilever arms are connected rigidly to each other for forming a storage-location module, wherein each of the storage-location modules is adapted for storing individual piece goods and comprises hanging devices for releasably connection to the rack stands.

By forming the racks in a modular manner an operator of the warehouse system can select at any time differently high and differently many rack planes. The height of the rack planes is from time to time dependent on the dimensions of the storage goods which are to be stored. Thus, the warehouse system is modular. Further, the warehouse system can be scaled by the operator of the warehouse system at any time, i.e. the warehouse can be enlarged or reduced.

With another preferred embodiment the cantilever arms define one storage plane which is declined in the direction of the rack stand relative to the horizontal line.

Hence, the cantilever arms decline, if viewed from the rack aisle, slightly to the back. On the one hand, this ensures that the stored storage goods are sitting safely in the rack and cannot move towards the rack aisle due to shocks or vibrations. On the other hand storage process is facilitated. If it should happen that one storage good, which is to be stored, has not been put completely on the cantilever arms, then the declined cantilever arms prevent the to-be-stored storage good from being pulled back again onto the loading platform by mistake.

According to a seventh aspect of the invention it is disclosed a method for storing and retrieving storage goods in and from a storage rack provided with cantilever arms by means of a load handling device which is connected to a storage and retrieval device, wherein the method comprises the following steps of: moving the storage and retrieval device in a longitudinal direction along a storage and retrieval side of the storage rack to a storage-good transfer position; extracting a tine comb of the load handling device in a transverse direction from a loading platform of the load handling device towards the cantilever arms of the storage rack so that the tine comb and the cantilever arms are meshing with each other; rotating the tine comb about a rotation axis parallel to the longitudinal direction for lifting or lowering an end of the tine comb, which faces the storage rack, in a height direction; and retracting the tine comb to the loading platform in a lifted or lowered state thereof.

According to an eighth aspect of the invention it is disclosed A method for storing and retrieving storage goods in a warehouse system comprising at least one cantilever-arm storage rack having a storage and retrieval side, wherein the cantilever-arm storage rack comprises: a plurality of rack stands and cantilever arms, which are fixed to the rack stands, wherein the cantilever arms are distanced to each other in a longitudinal direction and substantially extend in a transverse direction; and a storage and retrieval device, the storage and retrieval device being adapted to travel in the longitudinal direction along the storage and retrieval side of the cantilever-arm storage rack, and being adapted to be positioned in front of the storage and retrieval side such that storage goods can be stored and retrieved in the transverse direction, wherein the storage goods are put on the cantilever arms for storage, the storage and retrieval device having a carriage, a hoist unit, at least one mast, and at least one load handling device, each of the at least one load handling devices comprising: a loading platform; at least one tine comb respectively comprising a tine support and a plurality of tines which are substantially oriented in the transverse direction and are distanced to each other in the longitudinal direction so that each of the tines can reach into a space between neighbouring cantilever arms of the cantilever-arm storage rack for delivering or lifting one or more of the storage goods on or from the neighbouring cantilever arms, wherein the plurality of tines are connected to each other in the longitudinal direction by means of the tine support; a drive device for retracting and extracting the at least one tine comb in the transverse direction into and from the spaces; and a rotation device for rotating the at least one tine comb for the delivering and lifting of the one or more of the storage goods on and from the cantilever arms, when the tines are in the spaces between the neighbouring cantilever arms of the cantilever-arm storage rack, around a rotation axis which is oriented parallel to the longitudinal direction, thereby allowing an end of the at least one tine comb, which is facing the cantilever-arm storage rack, to be lifted or lowered rotationally in a height; the method comprising: driving the storage and retrieval device in the longitudinal direction along the storage and retrieval side of the cantilever-arm storage rack to a desired storage-good transfer position; extracting the at least one tine comb of the load handling device in the transverse direction from the loading platform of the load handling device towards the cantilever arms of the cantilever-arm storage rack so that the at least one tine comb and the cantilever arms mesh with each other; rotating the at least one tine comb around the rotation axis thereby lifting or lowering rotationally the end of the tine comb, which is facing the storage rack, in the height direction; and retracting the at least one tine comb to the loading platform in a lifted or lowered state thereof.

The pivotal tine comb allows storage and retrieval processes without requiring the load handling device to perform a (linear) lift by means of the hoist unit of the SRD. The load handling device of the SRD performs the lift by rotationally lowering or lifting the tine comb at one side thereof facing the rack side. This allows achievement of the advantages mentioned above in the context of the load handling device of the present invention.

It is clear that the above-mentioned and hereinafter still to be explained features cannot only be used in the respectively given combination but also in other combinations, or alone, without departing from the scope of the present invention.

Embodiments of the invention are illustrated in the figures and will be explained in more detail hereafter.

### BRIEF DESCRIPTION OF THE DRAWINGS

FIG. 1 shows a perspective partial sectional view along one rack aisle of a warehouse system where an SRD is used comprising a load handling device in accordance with the present invention;

FIG. 2 shows a perspective view of a load handling device in accordance with FIG. 1 which is illustrated in an isolated manner;

FIG. 3A+B show a side view along the rack aisle during a storage process, wherein FIG. 3A shows a starting position of the load handling device and FIG. 3B shows a delivery position, i.e. a receipt position, of the load handling device;

FIG. 4A+B show a detailed view of FIG. 2, wherein FIG. 4A shows a side view and FIG. 4B shows a front view of a camshaft used for rotating a tine comb of the load handling device;

FIG. 5 shows a side view along the rack aisle of FIG. 1 which is illustrated schematically;

FIG. 6 shows a detailed view of one cantilever arm;

FIG. 7 shows a view on a storage and retrieval side of the rack of FIG. 1, if the rack of FIG. 1 is viewed from the rack aisle;

FIG. 8 shows a top view of the partially depicted load handling device of FIG. 2 and an adjacent rack;

FIG. 9A+B show a modified load handling device in accordance with the invention; and

FIG. 10 shows a flow chart of a method for storing and retrieving storage goods in accordance with the present invention.

### DESCRIPTION OF PREFERRED EMBODIMENTS

In the following description identical features will be designated with identical reference numerals.

An SRD is to be understood in the following as a ground conveyor which typically travels, most times in a rail-guided manner, in a rack aisle between two racks. Often it comprises a carriage, one or more masts, a hoist unit and a load handling device. Light SRD are most times formed with one mast and seldomly with two masts for the purpose of multiple load receipts. In this case, a mast made of aluminum or steel is often having a box profile for ensuring a rigid construction at a low weight, if possible. The mast can be guided at an upper guiding rail and/or connected at a lower end to a ground support transmitting the forces to the ground rail through the supporting and guiding rollers. Drive devices are often equipped with friction wheel drives or serrated belts. A lifting drive of the SRD is frequently achieved by means of circulating traction means such as serrated belts, chains or wires. An omega drive device, which travels with the SRD, is suitable for higher accelerations, wherein the SRD is pulled along a serrated belt by means of a drive roller. In case of pallets, load receipt generally happens by means a fork, which can be extracted and retracted in a telescopic manner, wherein containers are received by means of belt conveyors, traction units such as hooks, lassos or pivotal arms or by means of lifting platforms or shuttles.

A storage unit is a handling unit, which is used in the storage area. A storage unit is typically provided in terms of one article type only, but the article types can also be mixed. The storage unit can comprise a load support as well as the storage good. The storage unit can also be realized by the storage good alone, if the load support is omitted. Usually, the load supports such as pallets, workpiece carriers, grid boxes, cargo containers, bins, trays and the like are used as the load supports. The storage goods comprise piece goods, bulk materials, liquids and gases. Bulk materials, liquids and gases require package means for the further handling, in order to define package pieces.

If it is referred to a vertical and horizontal orientations hereinafter, it is clear that the orientations can be exchanged at any time by rotation, and therefore are not to be interpreted in a limiting manner.

Warehouses are rooms or areas for keeping materials and goods for the sake of storage, buffering and distribution as well as for protection against external undesired influences (such as weather) and access (for example unauthorized removal). A rack warehouse typically comprises a plurality of racks which can be provided in terms of single racks or double racks. Double racks are single racks which are installed back-to-back. Rack aisles are defined between the racks, the rack aisles typically extending in a longitudinal direction of the racks and serve for receiving the SRD. The racks comprise a plurality of rack locations which are arranged in terms of rack planes being arranged on top of each other.

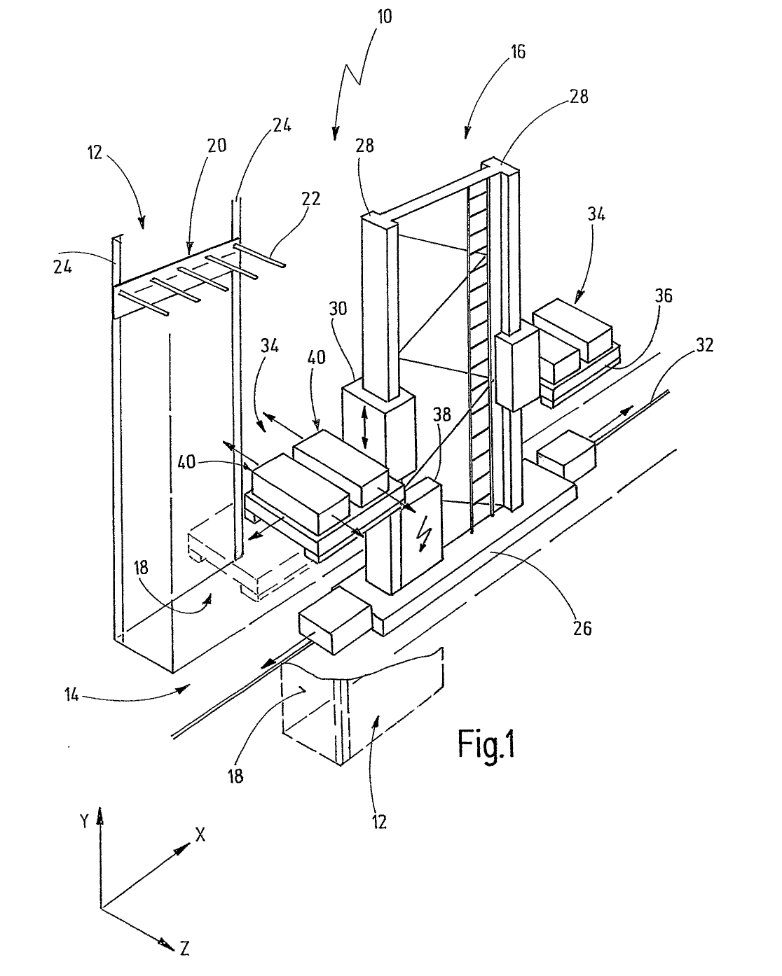

FIG. 1 shows a warehouse system 10 in accordance with the present invention.

The warehouse system 10 comprises storage racks 12, in particular cantilever arm storage racks, wherein oppositely arranged racks 12 define one rack aisle 14 therebetween. In the rack aisle 14 an SRD 16 can be driven in a longitudinal direction X. The SRD 16 travels along storage and retrieval sides 18 of the racks 12 which in turn are arranged adjacent to the rack aisle 14.

The racks 12 comprise rack stands 24 which can be connected to each other by means of storage-location modules 20. The storage-location modules 20 respectively comprise a plurality of cantilever arms 22. Each of the cantilever arms 22 is arranged with a distance relative its neighbouring cantilever arm 22 for allowing a load handling device of the SRD 16, which is to be described hereinafter, meshing with the cantilever arms 22. In this context, the cantilever arms 22 are distanced such that they are suitable for receiving storage goods, in particular piece goods, with or without load supports. Preferably, all of the cantilever arms 22 have the same distance relative to each other.

As an alternative to the storage-location modules 20 comprising a plurality of cantilever arms 22 as well as a transverse support 74 being connected rigidly to these cantilever arms 22, the rack stands 24 can also be connected to each other by means of transverse supports extending in the direction X, wherein the cantilever arms 22 in turn are inserted, or connected in another manner, to the transverse supports arbitrarily in accordance with a pre-given raster. In this manner the racks 12 can extend additionally in a height direction Y and a transverse direction Z. At the left-hand side of FIG. 1 one single rack is shown and at the right-hand side of the rack aisle 14 an additional single rack 12 is indicated by means of a broken line.

The SRD 16 comprises a carriage 26, which is presently drivable along a travel rail 32 arranged in the bottom as schematically indicated by means of two arrows. The SRD 16 further comprises two masts 28. It is clear that more or less masts 28 can be provided. A load handling device 34 in accordance with the present invention is movable in the height direction Y along each of the masts 28 by means of a hoist unit 30. The hoist unit 30 as well as the masts 28 can be omitted if the SRD 16 is intended for serving merely one individual rack plane.

Further, the SRD 16 comprises an electric cabinet 38 which can comprise a programmable logic controller (PLC), which in turn is connected with a superordinated material flow computer (not depicted here).

The load handling device 34 comprises a loading platform 36 on which one or more tine combs 40 are arranged as load handling devices. Each of the tine combs 40 comprises a plurality of tines 42, which preferably have an identical distance to each other, being oriented substantially in the transverse direction Z and being connected to each other by means of a tine support 44, which substantially extends in the longitudinal direction X. The tine support 44 serves for stiffening the tine comb 40. The tine support 44 is oriented, preferably, in a central position relative to the loading platform 36, if the load handling device 34 is in a starting position. The tine comb 40 can be extracted and retracted in a horizontal direction (direction Z) by means of a drive device which is not depicted here. This ability is indicated in FIG. 1 by means of arrows being oriented oppositely. The element being indicated by means of broken lines is intended to indicate that the loading platform can also be used for transfer processes within one and the same rack side. For this purpose the loading platform can also be movable or displaceable about one storage location position in the direction X (wherein the SRD 16 does not move). Of course, a drive can be used for this purpose which is here not depicted in more detail.

Additionally, it is clear that a plurality of load handling devices 34 can be arranged along the longitudinal direction X one after the other on the loading platform 36. The more load handling devices are arranged one after the other in the longitudinal direction X, the more storage goods can be stored and/or retrieved simultaneously.

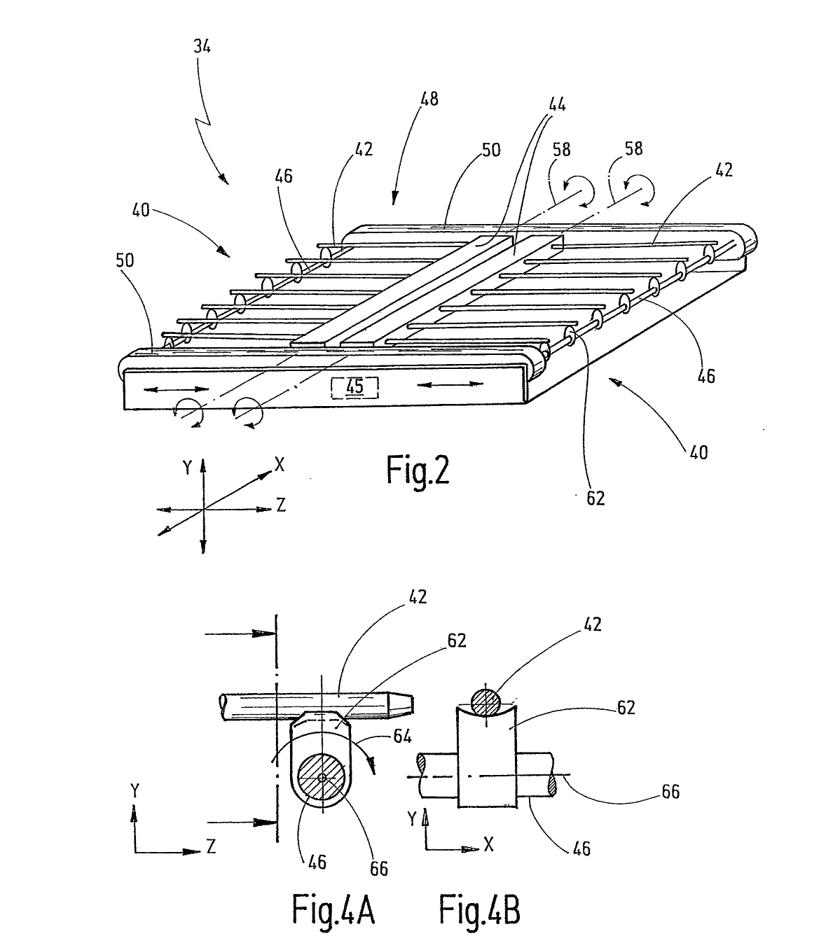

FIG. 2 shows a perspective view of a load handling device 34 being depicted in an isolated manner, such as the one which is exemplarily used with the SRD 16 of FIG. 1.

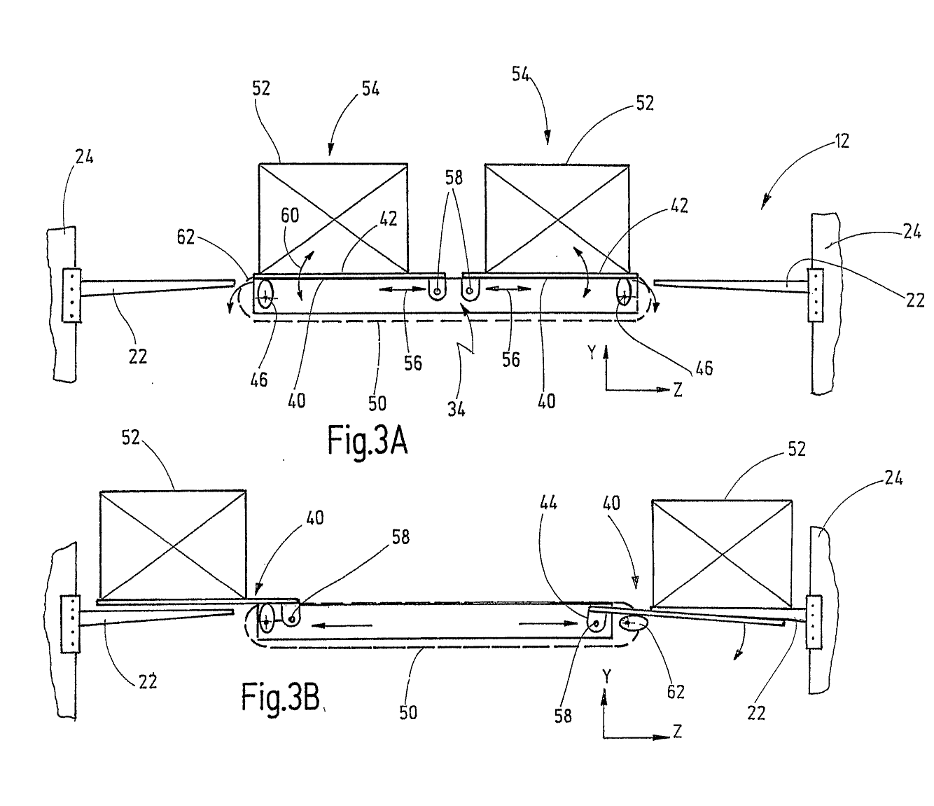

The load handling device 34 of FIG. 2 comprises two tine combs 40 being arranged side by side in the transverse direction Z and being supported respectively in a rotatable manner. A starting position of the load handling device 34 is shown in FIG. 2. The tine combs 40 are retracted. The tine combs 40 can be extracted and retracted in a horizontal direction (direction Z) by means of a drive device 45 which is presently indicated by means of a broken line (cf. FIG. 3B).

The tines 42 preferably have the same distance relative to each other. The tines 42 are connected to each other at one of their ends by means of the tine support 44, which extends substantially in the longitudinal direction X. The tine support 44 is arranged at one end of the tines 42 which is oriented towards the center of the load handling device 34. The respectively opposing ends of the tines 42 of one tine comb 40 are preferably not connected to each other (at least not within the plane of the tines 42), but can be supported, for example, by means of a shaft 46 which is supported eccentrically, the shaft 46 being preferably connected to cams 62. The arrangement of the cams 62 will be explained in more detail hereinafter with reference to FIGS. 4A and 4B.

Each of the tine combs 40 is supported pivotally around a rotation axis 58 in the area of the tine support 44 thereof. The rotation axis 58 can be moved together with the tine comb 40 in a horizontal direction as indicated by means of a double arrow.

The tine combs 40 are limited laterally by a transfer conveyor 48 in the lateral direction X, which comprises, for example, two driven endless belts 50. The transfer conveyor 48 can have a lifting functionality for lifting storage goods from one of the tine combs 40 and transferring same to the neighbouring tine comb 40 by driving the belts 50. Such a transfer process can be required if the storage goods need to be transferred from one of the racks 12 into the other rack 12, which is arranged adjacently in the same rack aisle 14. However, a transfer action can also be caused by multiple storage or retrieval processes at the same storage location.

It is clear that the belts 50 of the transfer conveyor 48 can also be formed differently. Instead of the belts 50, for example, also chains or the like can be used.

With reference to FIGS. 3A and 3B respectively a side view (view into the rack aisle 14 along the direction X) of the load handling device 34 as well as of the racks 12 arranged adjacently to the rack aisle 14 are shown. FIG. 3A shows the load handling device 34 in the starting position thereof during a storage process. FIG. 3B shows the tine combs 40 in an extracted position for storing storage goods 54, here in terms of piece goods 52, in the racks 12 without load supports.

In FIG. 3A the tine combs 40 are in their starting position, i.e. the tine supports 44 are located in the center of the loading platform 36 and are facing each other closely. A handling plane, which is defined by the tines 42, is oriented horizontally, i.e. lies in the plane XZ. The tine combs 40 can be driven in the horizontal direction Z along the arrows 56 and can be rotated around the rotation axis 58, as indicated by means of the double arrows 60. In this case, the cams 62 are in an upright position, as also shown in the FIGS. 4A and 4B.

FIG. 4A shows a section of one of the tines 42 of the load handling device 34 of FIG. 2, which is supported by a cam 62. FIG. 4A shows a side view and FIG. 4B shows a front view. The cam 62 is connected to the shaft 46 in a rotationally fixed manner and can be rotated around a rotation axis 66 of the shaft 46, as indicated by means of an arrow 64 in FIG. 4A. The cam 62 can have a concave recess, the contour of which is adapted to a contour of the tine 42.

It is clear that the cams 62 on the shaft 46 are distanced to each other in correspondence with the tines 42. The cams 62 support the tines 42 during an extraction movement of the tine combs 40 until the position of the tine combs 40 is reached which is shown in FIG. 3B.

Then, the tine combs 40 are rotated during the storage process of FIG. 3B around the rotation axis 58 thereof by rotating the cams 42 to a lying position, as indicated in FIG. 4A by means of the arrow 64. The rotation 64 of the cams 62 can be caused by means of a mechanical link which causes the rotation 64, for example, by contact if the tine support 44 reaches a predetermined position in the direction Z.

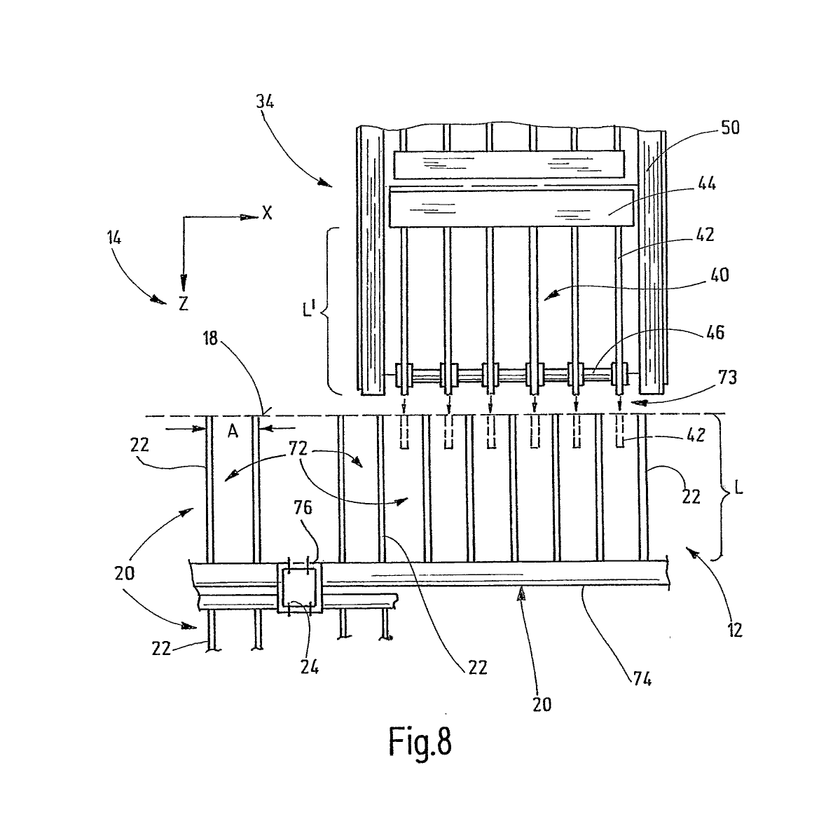

If the cams 62 rotate into the lying position, the tine comb 40 is lowered at the free end 73 thereof through the cantilever arms 22 (cf. also FIG. 8) and puts the piece good 52 in this manner on the cantilever arms 22. It is clear that the cams 62 can also be rotated further than 90° from the upright position to the lying position, which is dependent on the fact how deep the tines 42 need to be lowered for being guided completely through spaces 72 which are defined between the cantilever arms 22. The tine combs 40 need to be lowered during the storage so that the tine combs 40 can be moved freely beneath the cantilever arms 22 in both the direction Z and the direction X. Free movability along the direction X allows the SRD 16 in the rack aisle 14 (cf. FIG. 1) to already drive before the tine combs 40 have reached again their starting positions (cf. FIG. 3A) by driving the tine combs 40 back to the center of the loading platforms 36 and rotating the cams 62 back to their upright positions. In this manner time can be saved additionally. The same is true with regard to retrieval processes, wherein the tine comb 40 can already be extracted in the transverse direction Z if the SRD 16 or the loading platform 16 has reached a predetermined height along the direction Y.

It is clear that the distances between the SRD 16 and the cantilever arms 22, between the cantilever arms 22 and the lowered tines 42 as well as the dimension of the cams 62 are adapted to each other for allowing such movements.

The tine comb 40 being depicted at the right in FIG. 3B has already put its storage goods 52 on the cantilever arms 22 by lowering the tines 42. The tine comb 40 being depicted at the left of FIG. 3B is still in the extracted horizontal position thereof so that its associated piece good 52 cannot yet be put on the cantilever arms 22 of the left rack 12. An angle, which is more clearly shown in FIG. 6, can be recognized between the plane which extends between the tines 42 of the left tine comb 40 and a storage plane, being defined by the cantilever arms 22. Preferably, the cantilever arms 22 are slightly declined backwards with regard to the rack stands 24 and form an angle α (e.g. between) 1-10° relative to a horizontal line along which the tine combs 40 preferably move. It is ensured at any time that the piece goods 52 or the storage goods 54 are always sitting safe in the rack 12 by declining the cantilever arms 22 slightly backwards. The horizontal line is designated by 68 in FIG. 6 and defined by the plane XZ.

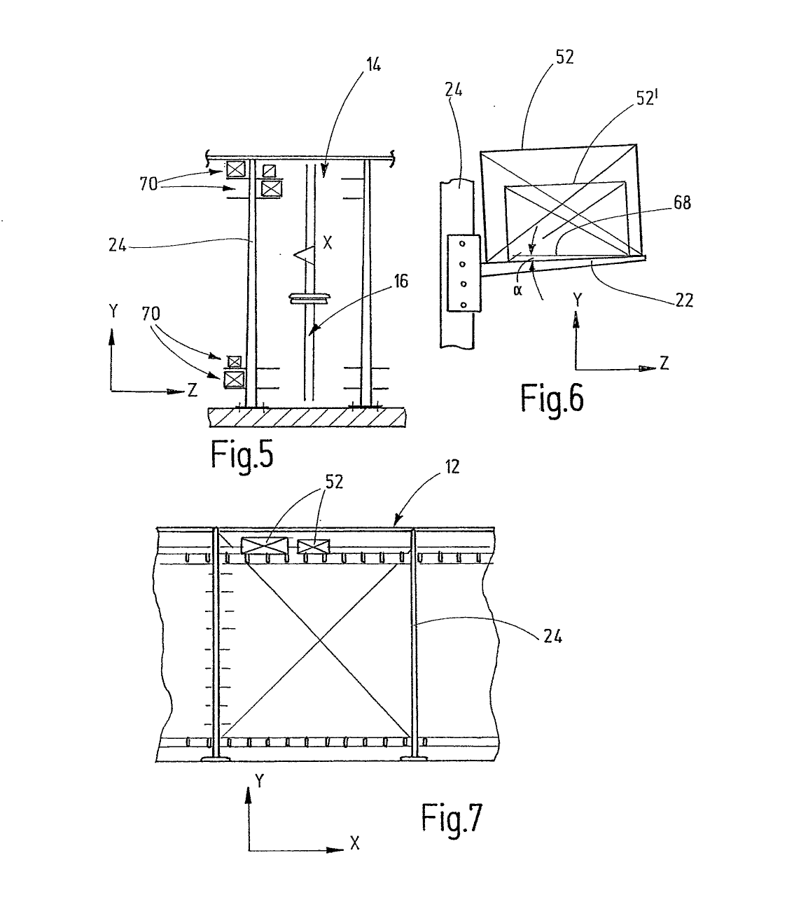

Only for the sake of completing an overall impression FIG. 5 shows a view into the rack aisle 14 of FIG. 1 along the direction X, and FIG. 7 shows a view of a front side 18 of a rack. In FIG. 5 a number of storage planes 70 are illustrated, which are defined by the cantilever arms 22 and/or storage-location modules 20. In FIG. 7 two piece goods 52 on a highest storage plane 70 are shown as lying freely (i.e. without load supports) on the cantilever arms 22.

With reference to FIG. 8 a top view on a part of the load handling device 34 is shown, which is shown in a storage-good transfer position with a storage-location module 20 being arranged directly oppositely.

The cantilever arms 22 have a distance A relative to each other and respectively define a space 72 therebetween. A free end 73 of the tine 42 of the shown tine comb 40 can travel into the space 72 along the transverse direction Z, as indicated by means of broken lines.

The tines 42 preferably comprise a length L′, which can be slightly longer than a length L of the cantilever arms 22. In this manner it is ensured that the tines 42 can travel sufficiently far into the spaces 72 without the danger of dropping one of the piece goods 52. The distances of the tines 42 are selected such that the tines 42 can mesh safely with the cantilever arms 22.

The cantilever arms 22 are a basic element of the storage-location module 20 which comprises a hanging device 76, by means of which the transverse support 74 of the storage-location module 20 can be attached releasably to the rack stands 24. The storage-location module 20 can preferably be hung into the rack stands 24.

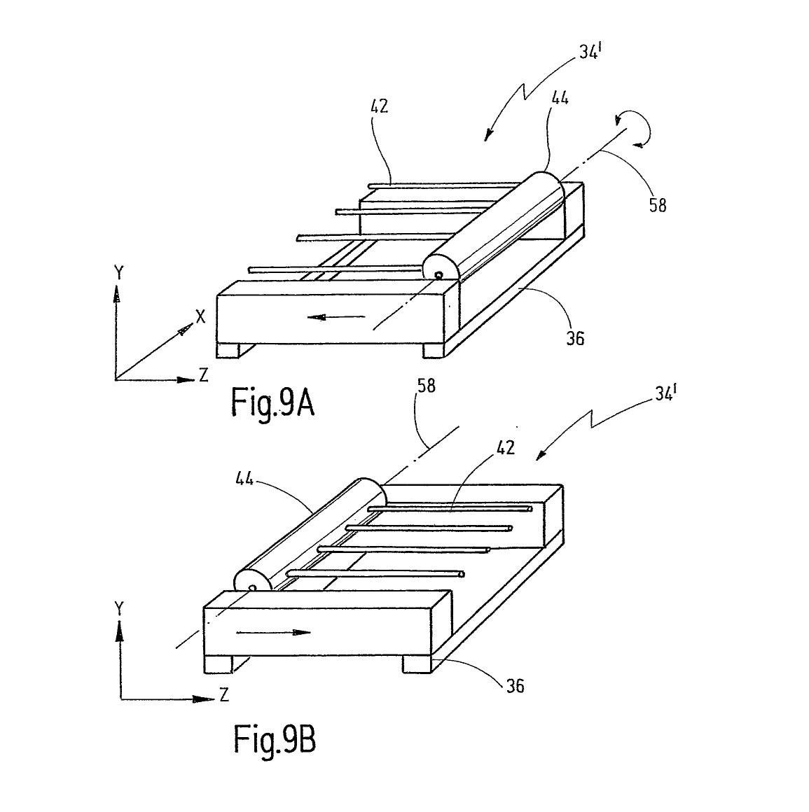

FIGS. 9A and 9B show an alternative load handling device 34′ in accordance with the present invention.

The load handling device 34′ comprises merely one single tine comb 40 in the transverse direction Z. Thereby the width of the loading platform 36 is reduced. The tine comb 40 can be moved again along the transverse direction Z. In FIG. 9A the tine comb 40 is oriented such that replacement of storage goods of the rack 12 is possible which is arranged at the left-hand side of the SRD 16. In order to allow an exchange of storage goods with the rack 12, arranged at the right-hand side, the tine comb 40 can be moved from the position shown in FIG. 9A to the position shown in FIG. 9B. For this purpose the tine support 44 travels along the direction Z to the left, wherein the tines 42 are folded by 180° around the rotation axis 58.

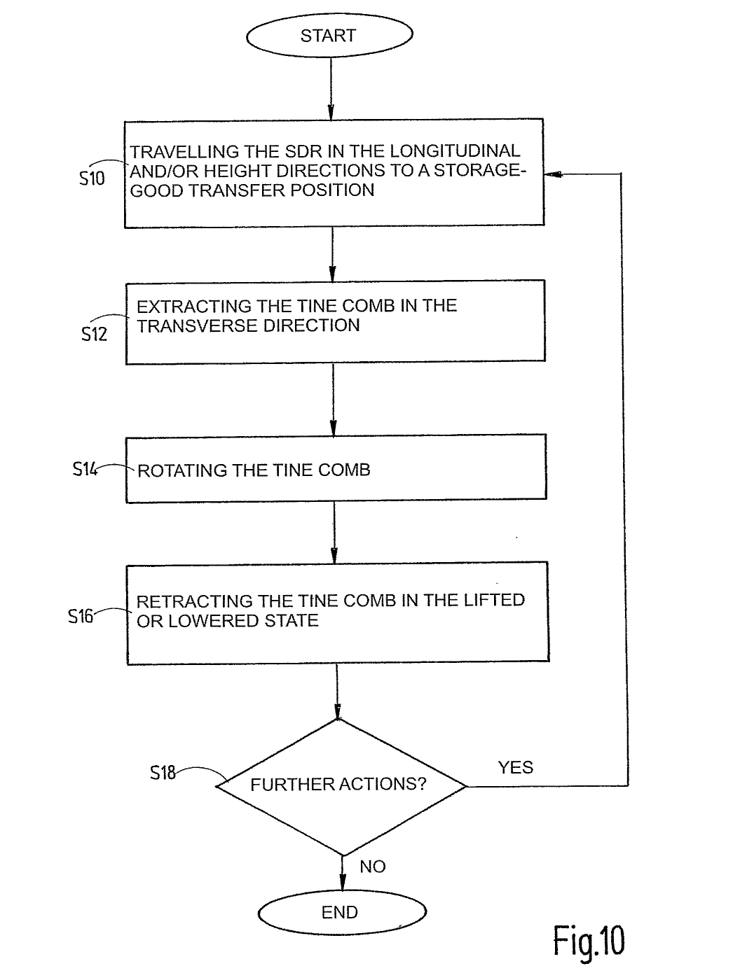

With reference to FIG. 10 a flow chart of the method for storing and retrieving storage goods in accordance with the present invention is shown. In a first step S10 the SRD 16 travels along a longitudinal direction (X) and/or height direction (Y) to a storage-good transfer position, as exemplarily shown in FIG. 8. In step S12 the tine comb 40 is extracted along the transverse direction Z (cf. FIG. 3B), for being rotated subsequently (cf. right-hand part of FIG. 3B). If the storage good 54 is lowered or retrieved, the tine comb 40 is driven back in step S16. Then, it is inquired in step S18 whether additional storage-good transfer actions are present. If no further actions are present, the method ends. If further actions are present, one returns to the step S10.

It is clear that the storage goods 54 can also be retrieved by inversion of the processes. In this case the tine combs 40 are driven, in their lowered state (cams 62 are in their lying position), below the cantilever arms 22. As soon as the tines 42 reach their receiving position (cf. FIG. 3B at the right-hand side) the cams 62 are rotated to their upright position, thereby moving the tines 42 through the spaces 72 between the cantilever arms 22 and lifting the storage good 54 from the rack 12. For this purpose the cam 62 can be formed such that the handling plane of the tine comb 40 is slightly inclined relative to the horizontal line 68, so that the tines 42 can be extracted along the transverse direction Z from the rack 12 without allowing the storage good 54 to jam with the cantilever arms 22.

Further it is clear that the rotation device, which is presently described in terms of a combination of the tine support 44 and the camshaft 46, can also be implemented differently. The provision of the shaft 46 having the cams 62 is not required necessarily. Thus, the tine support 44 can also be rotated independently, for example, by a drive. Further, devices can be provided in the area of the racks 12, which cause the free end 73 of the tine comb 40 to lift and lower.

Instead of the cantilever arms 22 rack compartments formed of trapezoidal sheets or shelves having individual seatings can be provided, wherein the tine comb 40 can travel into the corresponding free spaces (corresponding to interstices).

With another alternative embodiment the tine combs 40 are not arranged back-to-back with their tine supports 44, as shown in FIG. 2, but are arranged oppositely. In this case the tine support 44 is arranged outside relative to the loading platform 36 in the starting position thereof, wherein an opening of the left tine comb 40 is arranged oppositely to the comb support 44 almost directly of the right tine comb, and vice versa an opening of the right tine comb 40 is almost directly opposite to the left tine support. The tine combs 40 are meshing with each other in the starting position and can be moved against each other to the respective storage/retrieval position. The rotation axis 58 of the tine combs can act simultaneously as eccentric shafts 46 of the opposite tine combs 40. If one of the tine combs is driven horizontally to the storage/retrieval position thereof, the other tine comb 40 can be rotated to a position so that the tines 42 thereof protrude upwardly from the plane of the tine combs. The cams 62 can be moved from their upright position to their lying position by this rotation. For this purpose, the tine supports 44 are not formed continuously in the area of the rotation axis 58, as shown in FIG. 2, but are divided such that the cams 62 of the opposite tine comb 40 can be arranged therebetween. Shortening of the loading platform in the direction Z about almost the half in comparison to the FIGS. 1 and 2 is achieved by this design. A correspondingly equipped SRD 16 can be used in a much smaller rack aisle than the SRD 16 of FIG. 1.

Of course, this embodiment can also be equipped with a transfer conveyor 48, namely with or without separate lifting functionality. It can be determined by the contour of the cams 62 how big or small the lift of the tine combs 40 turns out or how much room is present for driving the tine combs 40.

What is claimed is:

1. A load handling device of a storage and retrieval device, which travels in a longitudinal direction of a rack aisle along a storage and retrieval side of a cantilever-arm storage rack, and which can be positioned in front of the storage and retrieval side such that storage goods can be stored and retrieved in a transverse direction, wherein the storage rack comprises a plurality of cantilever arms on which the storage goods are put for storage, wherein the cantilever arms are distanced to each other in the longitudinal direction and substantially extend in the transverse direction, comprising:
a loading platform;
at least one tine comb respectively comprising a tine support and a plurality of tines which are substantially oriented in the transverse direction and are distanced to each other in the longitudinal direction so that each of the tines can reach into a space between neighbouring cantilever arms of the storage rack for delivering or lifting one or more of the cantilever-arm storage goods on or from the neighbouring cantilever arms, wherein the plurality of tines are connected to each other in the longitudinal direction by means of the tine support;
a drive device for retracting and extracting the at least one tine comb in the transverse direction into and from the spaces;
and a rotation device for rotating the at least one tine comb for the delivering and lifting the one or more of the storage goods on and from the cantilever arms, when the tines are in the spaces between the neighbouring cantilever arms of the cantilever-arm storage rack, around a rotation axis, which is oriented parallel to the longitudinal direction, thereby allowing one end of the at least one tine comb, which is facing the cantilever-arm storage rack, to be lifted or lowered rotationally in a height direction.

2. The load handling device of claim 1, wherein each of the tine combs can be lowered so deeply that the storage and retrieval device can travel freely in the longitudinal direction while the at least one tine comb is extracted.

3. The load handling device of claim 1, wherein the drive device comprises a drive member, and a transmission member connected to the tine comb.

4. The load handling device of claim 1, wherein the rotation axis is arranged along the tine support.

5. The load handling device of claim 1, wherein the rotation device comprises a shaft and a plurality of cams, the cams being attached to the shaft andarranged at an edge of the loading platform, which faces the storage rack so that the one end of the at least one tine comb is lifted or lowered in an extracted position relative to the cantilever arms due to a rotation of the shaft.

6. The load handling device of claim 1, wherein only one single tine comb is provided along the transverse direction, the one single tine comb being rotateable additionally around 180° for allowing serving both sides of the rack aisle, wherein the rack aisle is defined by two opposite cantilever-arm storage racks being distanced to each other in the transverse direction.

7. The load handling device of claim 1, wherein respectively two tine combs are arranged side-by-side along the transverse direction.

8. The load handling device of claim 7, wherein further comprising a transfer conveyor which is arranged on the loading platform and formed so that the storage goods can be transported from one of the respectively two tine combs to the other one of the respectively two tine combs.

9. A storage and retrieval device being adapted to travel in a longitudinal direction of a rack aisle along a storage and retrieval side of a cantilever-arm storage rack, and to be positioned in front of the storage and retrieval side such that storage goods can be stored and retrieved in a transverse direction, wherein the cantilever-arm storage rack comprises a plurality of cantilever arms on which the storage goods are put for storage, the cantilever arms being distanced to each other in the longitudinal direction and substantially extend in the transverse direction, the storage and retrieval device having a carriage, a hoist unit, at least one mast, and at least one load handling device, each of the at least one load handling devices comprises:
a loading platform;
at least one tine comb respectively comprising a tine support and a plurality of tines which are substantially oriented in the transverse direction and are distanced to each other in the longitudinal direction so that each of the tines can reach into a space between neighbouring cantilever arms of the cantilever-arm storage rack for delivering or lifting one or more of the storage goods on or from the neighbouring cantilever arms, wherein the tines are connected to each other in the longitudinal direction by means of the tine support;
a drive device for retracting and extracting the at least one tine comb in the transverse direction into and from the spaces;
and a rotation device for rotating the at least one tine comb for the delivering and lifting of the one or more of the storage goods on and from the cantilever arms, when the tines are in the spaces between the neighbouring cantilever arms of the cantilever-arm storage rack, around a rotation axis, which is oriented parallel to the longitudinal direction, thereby allowing an end of the at least one tine comb, which is facing the cantilever-arm storage rack, to be lifted or lowered rotationally in a height direction.

10. A warehouse system comprising at least one cantilever-arm storage rack having a storage and retrieval side, wherein the cantilever-arm storage rack comprises:
a plurality of rack stands and cantilever arms, which are attached to the rack stands, wherein the cantilever arms are distanced to each other in a longitudinal direction and substantially extend in a transverse direction;
and a storage and retrieval device, the storage and retrieval device being adapted to travel in the longitudinal direction along the storage and retrieval side of the cantilever-arm storage rack, and being adapted to be positioned in front of the storage and retrieval side such that storage goods can be stored and retrieved in the transverse direction, wherein the storage goods are put on the cantilever arms for storage, the storage and retrieval device having a carriage, a hoist unit, at least one mast, and at least one load handling device, each of the at least one load handling devices comprising:
a loading platform;
at least one tine comb respectively comprising a tine support and a plurality of tines which are substantially oriented in the transverse direction and are distanced to each other in the longitudinal direction so that each of the tines can reach into a space between neighbouring cantilever arms of the cantilever-arm storage rack for delivering or lifting one or more of the storage goods on or from the neighbouring cantilever arms, wherein the plurality of tines are connected to each other in the longitudinal direction by means of the tine support;
a drive device for retracting and extracting the at least one tine comb in the transverse direction into and from the spaces;
and a rotation device for rotating the at least one tine comb for the delivering and lifting the one or more of the storage goods on and from the cantilever arms, when the tines are in the spaces between the neighbouring cantilever arms of the cantilever-arm storage rack, around a rotation axis which is oriented parallel to the longitudinal direction, thereby allowing an end of the at least one tine comb, which is facing the cantilever-arm storage rack, to be lifted or lowered rotationally in a height direction.

11. The warehouse system of claim 10, comprising at least one storage-location module respectively comprising several ones of the cantilever arms which are connected rigidly, wherein each storage-location module comprises hanging devices for a releasable connection to the rack stands.

12. The warehouse system of claim 10, wherein the cantilever arms define a storage plane which is declined relative to a horizontal line towards the rack stands.

13. A method for storing and retrieving storage goods in a warehouse system comprising at least one cantilever-arm storage rack having a storage and retrieval side, wherein the cantilever-arm storage rack comprises: a plurality of rack stands and cantilever arms, which are fixed to the rack stands, wherein the cantilever arms are distanced to each other in a longitudinal direction and substantially extend in a transverse direction; and a storage and retrieval device, the storage and retrieval device being adapted to travel in the longitudinal direction along the storage and retrieval side of the cantilever-arm storage rack, and being adapted to be positioned in front of the storage and retrieval side such that storage goods can be stored and retrieved in the transverse direction, wherein the storage goods are put on the cantilever arms for storage, the storage and retrieval device having a carriage, a hoist unit, at least one mast, and at least one load handling device, each of the at least one load handling devices comprising: a loading platform; at least one tine comb respectively comprising a tine support and a plurality of tines which are substantially oriented in the transverse direction and are distanced to each other in the longitudinal direction so that each of the tines can reach into a space between neighbouring cantilever arms of the cantilever-arm storage rack for delivering or lifting one or more of the storage goods on or from the neighbouring cantilever arms, wherein the plurality of tines are connected to each other in the longitudinal direction by means of the tine support; a drive device for retracting and extracting the at least one tine comb in the transverse direction into and from the spaces; and a rotation device for rotating the at least one tine comb for the delivering and lifting of the one or more of the storage goods on and from the cantilever arms, when the tines are in the spaces between the neighbouring cantilever arms of the cantilever-arm storage rack, around a rotation axis which is oriented parallel to the longitudinal direction, thereby allowing an end of the at least one tine comb, which is facing the cantilever-arm storage rack, to be lifted or lowered rotationally in a height; the method comprising:
driving the storage and retrieval device in the longitudinal direction along the storage and retrieval side of the cantilever-arm storage rack to a desired storage-good transfer position;
extracting the at least one tine comb of the load handling device in the transverse direction from the loading platform of the load handling device towards the cantilever arms of the cantilever-arm storage rack so that the at least one tine comb and the cantilever arms mesh with each other;
rotating the at least one tine comb around the rotation axis thereby lifting or lowering rotationally the end of the tine comb, which is facing the storage rack, in the height direction; and
retracting the at least one tine comb to the loading platform in a lifted or lowered state thereof.
